(19) United States
(12) Patent Application Publication
(10) Pub. No.: US 2026/0021698 A1
(43) Pub. Date: Jan. 22, 2026

(54) ELECTRIC DRIVE SYSTEM AND METHOD FOR ITS OPERATION

(71) Applicant: MERCEDES-BENZ GROUP AG, Stuttgart (DE)

(72) Inventors: Tobias SCHILDER, Ludwigsburg (DE); Harald KRAUS, Esslingen (DE); Felix PAULI, Schorndorf (DE); Raphael MIETH, Leonberg (DE)

(21) Appl. No.: 19/107,198

(22) PCT Filed: Jul. 14, 2023
(86) PCT No.: PCT/EP2023/069596

§ 371 Date: Feb. 27, 2025

(30) Foreign Application Priority Data
Aug. 29, 2022 (DE) 10 2022 003 150.7

(51) Int. Cl. B60K 17/356; B60K 1/02; B60K 17/26; B60L 15/20

(52) U.S. Cl. CPC B60K 17/356; B60K 1/02; B60K 17/26; B60L 15/2036; B60L 2220/42; B60L 2220/52; B60L 2260/28

(57) ABSTRACT

An electric drive system includes electrically driven front and rear axles. The electrically driven rear axle has a first electric engine having a first rotor to drive a first rear wheel. The electrically driven rear axle has a third electric engine having a third rotor to drive a second rear wheel. The electrically driven front axle has a second electric engine having a second rotor to drive front wheels via a second axle drive. The second rotor is coupled in a torque-transmitting manner via the second axle drive permanently to a first front wheel and permanently to a second front wheel. A first switchable freewheel clutch is provided to couple the first rotor to the first rear wheel in a torque-transmitting manner. A second switchable freewheel clutch is provided to couple the second rotor to the second rear wheel in a torque-transmitting manner.

### BACKGROUND AND SUMMARY OF THE INVENTION

Exemplary embodiments of the invention relate to an electric drive system for a motor vehicle, having an electrically driven front axle and an electrically driven rear axle, as well as to a method for operating the electric drive system is presented.

Electric drive systems for motor vehicles are known from the general prior art. In this case, for example, a front axle of the motor vehicle can be electrically driven, as can a rear axle. DE 10 2018 220 809 A1 describes a vehicle of such type, with the description focusing on the power electronic control of the electric drive system. The vehicle depicted by way of example shows a drive system in which a first electric engine drives a first rear wheel, a second electric engine drives a second rear wheel and a third electric engine drives the front wheels of the shown vehicle via an axle drive, such as a differential, for example. DE 10 2016 218 717 B3 and the generic DE 10 2018 217 863 A1 disclose electric drive systems for motor vehicles having two electrically driven axles and in total at least three electric engines.

DE 10 2019 202 207 A1 discloses an electrically driven axle of a motor vehicle, wherein two electric engines are provided.

DE 10 2011 080 236 A1 describes an alternative to this. In this document, a drive device for an individual wheel of a motor vehicle is described, which could also be used for two or more wheels of the motor vehicle. In this case, an electric engine is provided for each driven wheel. The rotor of this electric engine is coupled to the respective driven wheel via a planetary gear stage.

Reference can also be made to DE 10 2020 127 790 A1 and to DE 10 2019 121 215 A1. In these documents, in each case an activatable electric engine is described which can be activated via a planetary gear stage with a freewheel.

Furthermore, the underlying principle of an activatable four-wheel drive for a non-electrically driven motor vehicle is described in DE 38 01 351 A1.

Exemplary embodiments of the present invention are directed to an improved electric drive system which enables an energy-saving operating mode and simultaneously allows an increase in driving performance, traction, dynamics and/or safety, when needed.

The electric drive system according to the invention uses a basic structure, which is shown in principle in the generic document mentioned in the introduction. It consists substantially of an electrically driven front axle and an electrically driven rear axle and can preferably be used in passenger cars, light commercial vehicles and the like. A further application, for example in heavy commercial vehicles or the like, such as construction machinery, military vehicles or similar, would also be fundamentally conceivable.

The electrically driven rear axle comprises a first electric engine having a first rotor designed to drive a first rear wheel and/or a second rear wheel of the electrically driven rear axle. The electrically driven front axle comprises a second electric engine having a second rotor designed to drive front wheels of the electrically driven front axle via a second axle drive, for example a differential or a distribution gearbox.

Furthermore, in a known manner, the second rotor is coupled in a torque-transmitting manner via the second axle drive permanently to a first front wheel of the front wheels and permanently to a second front wheel of the front wheels. The second electric engine therefore drives the two front wheels of the electrically driven front axle via the second axle drive, in the present case without the possibility of decoupling. The electrically driven front axle thus represents that driven axle which predominantly ensures the propulsion of the motor vehicle. In particular, the electrically driven or drivable front axle ensures propulsion in the case of low power requirements or part load.

In a known manner, a first switchable freewheel clutch is also provided, which is designed to couple the first rotor to the first rear wheel and/or to the second rear wheel in a torque-transmitting manner. In comparison to the permanently coupled front wheels, it is provided for the two rear wheels of the electrically driven rear axle that these can be driven optionally, whenever there is the need to drive these rear wheels.

Furthermore, it is provided in a known manner that the first switchable freewheel clutch has a first actuator, wherein by means of the first switchable freewheel clutch, the torque-transmitting coupling of the first rotor to the first rear wheel and/or the second rear wheel can be produced in a forwards traction operation of the first electric engine without the intervention of the first actuator and the torque-transmitting coupling can be produced with the intervention of the first actuator in a forwards thrust operation or a reverse traction operation of the first electric engine.

The electric drive system now enables the second electric engine to drive exclusively the front axle during a low-load journey, which constitutes the largest proportion of a vehicle's many intended uses. As a result, it is possible to operate the electric drive system at a high level of efficiency. The second electric engine can therefore be ideally designed for operation in these more likely low-load ranges, whereby a high level of efficiency is possible.

It is now possible, during a higher-load journey, to activate the wheels of the rear axle, as needed, by means of the first electric engine and the first switchable freewheel clutch. The electrically driven rear axle serves to increase the driving performance, the traction force, or also the driving experience and thus ultimately the dynamics.

Freewheel clutch means a coupling having a known freewheel mechanism having two rotatably mounted coupling halves. It is possible to couple the two coupling halves in a torque-transmitting manner by means of the freewheel mechanism if, for example, a first coupling half of the two coupling halves is driven, wherein the two coupling halves are decoupled from each other if the first coupling half is not driven. The first coupling half is advantageously permanently coupled to the first electric engine in a torque-transmitting manner.

The first actuator means a mechanism which, due to an electric signal or several different electric signals, can effect a mechanical coupling or decoupling or a coupling capability or a decoupling capability of the mentioned coupling halves.

The forwards traction operation of the first electric engine means an operating mode of the first electric engine in which the electric engine is driven in a rotational direction, by means of which the rear wheels can be moved in a forwards movement.

The statement that the torque-transmitting coupling is produced “without the intervention of the actuator” means that no signal change at the first actuator and also no position change of parts of the first actuator take place for a transition between the decoupled state of the two coupling halves and the coupled state. Unlike with an actuator-operated claw coupling, the torque-transmitting coupling takes place without the intervention of the first actuator without the need to synchronize the rotational speeds of the two coupling halves by a synchronization method. The synchronization necessary to close the two coupling halves takes place practically without a time delay by means of the freewheel mechanism of the freewheel clutch.

Forwards thrust operation, in relation to one of the electric engines, is an operation in which the respective rotor is thrust by the motor vehicle if the respective electric engine is coupled to the respective wheel in a torque-transmitting manner, namely in a rotational direction for a forwards operation of the motor vehicle.

Reverse traction operation, in relation to one of the electric engines, is an operation in which the respective rotor is operated in a driven manner if the respective electric engine is coupled to the respective wheel in a torque-transmitting manner, namely in a rotational direction for reverse operation of the motor vehicle.

Furthermore, in a known manner it is provided that the electrically driven rear axle has a third electric engine having a third rotor designed to drive the second rear wheel and/or the first rear wheel of the electrically driven rear axle. In this case, a second switchable freewheel clutch having a second actuator is provided which is designed to couple the third rotor to the second rear wheel in a torque-transmitting manner.

In this manner, the electrically driven rear axle can be driven in a torque vectoring mode. Safety in all-wheel drive mode can also be increased as a result, which is achieved in the region of the electric rear axle by the two electric engines and the rear wheels that can be driven independently by said engines.

According to the invention it is provided that the first electric engine and the second electric engine are designed as axial flow machines and are arranged in a common housing having a common oil chamber, wherein this housing can be that housing with respect to which the element of the two planetary gear stages can be fixed via the switchable freewheel, for example. However, it is also possible to use several individual housings or housing parts. According to the invention, the first planetary gear stage, the second planetary gear stage, the first switchable freewheel clutch, and the second switchable freewheel clutch are arranged in the common housing and in the common oil chamber.

According to a further development of the electric drive system according to the invention, a first planetary gear stage is provided between the first rotor and the first rear wheel and/or the second rear wheel, with regard to a torque flow originating from the first rotor.

Advantageously, a second planetary gear stage is also arranged between the third rotor and the second rear wheel, with regards to a torque flow originating from the third rotor. The first rotor, the second rotor, the first planetary gear stage, and the second planetary gear stage are in this case all arranged coaxially to each other. Coaxially in the context of the present invention means that their rotational axes are aligned so that they lie behind each other for example with their main rotational axes on one axis in the direction of the axis. As a result, a correspondingly compact construction is possible.

According to a further development of this idea, it can be provided that the first switchable freewheel clutch is designed to couple a first output shaft of the first planetary gear stage to the first rear wheel for conjoint rotation.

Accordingly, it can be provided that the second switchable freewheel clutch is designed to couple a second output shaft of the second planetary gear stage to the second rear wheel for conjoint rotation.

A coupling for conjoint rotation in the context of the invention is to be understood to mean a coupling which results in the coupled components rotating at the same angular velocity after the coupling.

The construction therefore provides the freewheel clutch between the respective planetary gear stage and the respective rear wheel, so that it lies between the output shaft of the planetary gear stage and the rear wheel.

In an alternative variant of the embodiment having the planetary gear stages, it can also be provided that the first switchable freewheel clutch is designed to connect an element of the first planetary gear stage, for example and preferably the ring gear thereof, to a housing for conjoint rotation. Analogously, the second switchable freewheel clutch can be designed to connect an element of the second planetary gear stage, and here in particular the same element, i.e., preferably similarly again the ring gear, to the housing for conjoint rotation. The freewheel clutches are therefore integrated into the planetary gear stages and allow the corresponding element of the planetary gearbox, preferably—but not necessarily—the ring gears, to either rotate freely or hold it firmly in place, accordingly. Due to this design as a freewheel, the connection for conjoint rotation to be achieved by the switchable freewheel clutches refers to the drive case, while in the case that the rear wheels are not being driven, they freewheel accordingly, so that the drive via the electrically driven front axle alone can be used to move the vehicle.

A further very favorable embodiment of the electric drive system can alternatively provide that a superposition gear comprising a first drive shaft, a second drive shaft, a first output drive shaft, and a second output drive shaft is arranged axially between the first rotor and the third rotor. The first rotor is connected to the first drive shaft for conjoint rotation, the third rotor is accordingly connected to the second drive shaft for conjoint rotation. The first output drive shaft is in turn connected to a first input shaft of the first planetary gear stage for conjoint rotation and the second output drive shaft is connected to a second input shaft of the second planetary gear stage for conjoint rotation. As a result, superposition, for example, by a superimposed planetary gear set is possible, in order to be able to drive each of the two rear wheels via both electric engines connected to said gear set, i.e., the first and the third electric engine.

A very advantageous embodiment of this can also provide that the first planetary gear stage, the second planetary gear stage, the first switchable freewheel clutch, and the second switchable freewheel clutch are arranged in the common housing and the common oil chamber. This enables a very compact construction, in which now, in particular, the advantages of the common oil chamber are shared by the planetary gear stages and the switchable freewheels, in order to accommodate the entire gear shift and drive system of the electrically driven rear axle in a common housing.

According to an extraordinarily favorable further development of this idea of the invention, it can now be further provided that a rotor shaft of the first rotor is mounted between the first rotor and the third rotor against a third rotor shaft of the third rotor. Thus, mounting the rotor shafts with respect to the housing axially between the first rotor and the third rotor can be dispensed with. The first rotor is therefore supported axially between these two rotors exclusively on the third rotor shaft and vice versa, so that additional mounting technology and the friction loss associated with it can be dispensed with. Due to the corresponding support of the rotor shafts via mounting them on each other, they can be moved independently of each other. If, however, they are moved together at the same rotational speed or at a very similar rotational speed, the friction loss is minimized by the relative mounting between the two rotor shafts due to the lacking or very low relative speed of the rotor shafts with respect to each other.

With regard to the electrically driven front axle, it can be provided in the electric drive system of the invention according to a very advantageous further development that the second electric engine, the axle drive, a third planetary gear stage, and the first front wheel are arranged successively in the mentioned order with regard to a torque flow originating from the second electric engine. Analogously, with regard to a torque flow originating from the second electric engine, this second electric engine, the axle drive, a fourth planetary gear stage, and the second front wheel can then also be arranged successively in the mentioned order. In this particularly favorable embodiment of the electric drive system, according to the invention, the second electric engine for the electrically driven front axle therefore drives two planetary gear stages, which are in turn coupled permanently to the driven front wheels in a torque-transmitting manner, via the axle drive, for example a differential.

As an alternative to this arrangement of the planetary gear stages between the axle drive and the respective driven wheel of the front axle, it can also be provided in a very advantageous embodiment that the second electric engine, a further planetary gear stage, the axle drive, and the first front wheel originating from the axle drive on the one hand and the second front wheel originating from the axle drive on the other hand are each arranged successively in the mentioned order with regard to a torque flow output by the second electric engine. In this alternative, rather than a third and a fourth planetary gear stage, only one of these planetary gear stages is used. It directly follows the electric engine, meaning that the latter is coupled to the input shaft of the further planetary gear stage. Then, the torque is introduced via the output of this further planetary gear stage into the axle drive, which distributes the power flow to the two driven front wheels. The order of planetary gear stages and axle drive is therefore reversed, whereby one of the planetary gear stages can be omitted.

According to a very advantageous further development of these two variants of the electrically driven front axle, it can now also be the case that a parking lock is provided for the electrically driven front axle. Depending on the arrangement with regard to the torque flow, this parking lock can be arranged between the further planetary gear stage and the axle drive or between the axle drive and one or both of the third and/or fourth planetary gear stages, wherein in this case preferably only one parking lock is provided, i.e., either between the axle drive and the third planetary gear stage or the axle drive and the fourth planetary gear stage. In a known manner and with a known functionality, the drive can be locked accordingly in the case of a parked motor vehicle via such a parking lock.

Further advantageous embodiments of the electric drive system according to the invention result from the exemplary embodiments which are described in more detail below with reference to the figures.

### BRIEF DESCRIPTION OF THE DRAWING FIGURES

Here:

FIG. 1 shows a schematic illustration of a vehicle having an electric drive system according to the invention;

FIG. 2 shows a schematic illustration of a vehicle having an electric drive system according to the invention in a second embodiment;

FIG. 3 shows a possible embodiment of the essential elements of an electrically driven rear axle of the second embodiment according to the invention;

FIG. 4a shows a variant for mounting the rotor shafts of the first and second rotor in relation to each other;

FIG. 4b shows another variant for mounting the rotor shafts of the first and second rotor in relation to each other;

FIG. 5 shows a further possible embodiment of the essential elements of an electrically driven rear axle of the second embodiment according to the invention;

FIG. 6a shows a possible embodiment of the electrically driven front axle according to the invention; and

FIG. 6b shows another possible embodiment of the electrically driven front axle according to the invention.

### DETAILED DESCRIPTION

In the illustration of FIG. 1, a motor vehicle 1 is schematically represented, which in regular operation is to be moved from right to left in the illustration in the direction of travel F, i.e., when driving forward. The motor vehicle 1 is equipped with an electric drive system 100 having an electrically driven front axle 2 and an electrically driven rear axle 3. Drive energy for the electric drive system 100 is stored and is made available via a battery 4 or an alternative electric energy storage device.

The electrically driven rear axle 3 comprises a first electric engine 5 having a first rotor 6 designed to drive a first rear wheel 7 and a second rear wheel 10 via a first axle drive 66.

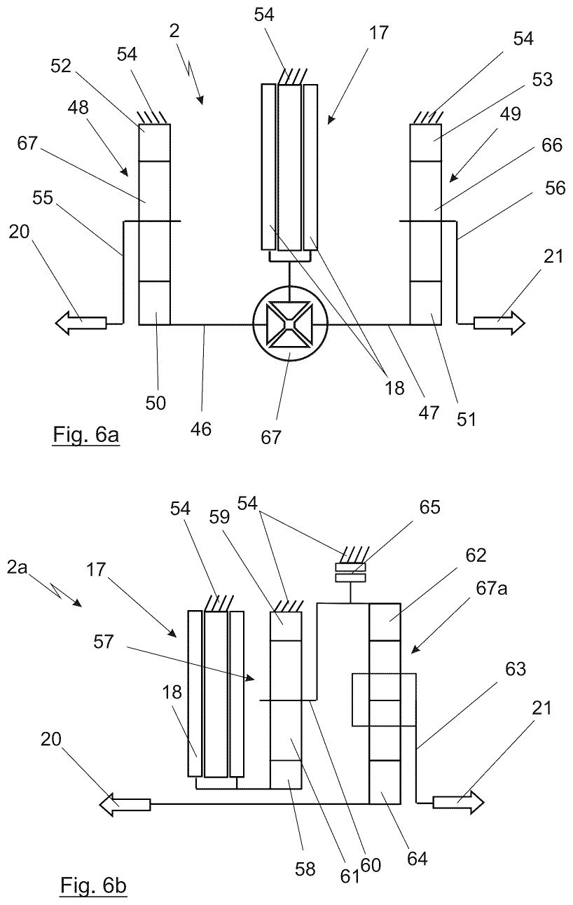

The electric drive system 100 also comprises the electrically driven front axle 2 in the direction of travel F at the front in the illustration of FIG. 1, i.e., on the left. This front axle 2 comprises a second electric engine 17 having a second rotor 18 which can be seen in the two illustrations of FIG. 6. It is possible to simultaneously drive two front wheels 20, 21, specifically a first front wheel 20 and a second front wheel 21, of the electrically driven front axle 2 by means of the second electric engine 17 via a second axle drive 67. The electrically driven front axle 2 also comprises a third and a fourth planetary gear stage 22, 23 and a power electronics unit 24 coupled to the battery 4 in the illustration of FIG. 1. The two driven front wheels 20, 21 are thus permanently coupled to the second rotor 18 of the second electric engine 17 via the second axle drive 67 and via the planetary gear stages 22, 23, so that unlike in the case of the electrically driven rear axle 3, an actuator system can be completely omitted in the region of the electrically driven front axle 2.

The electrically driven rear axle 3 also comprises a first planetary gear stage 11 and a first switchable freewheel clutch 13, which is represented integrated into the first planetary gear stage 11 in the illustration of FIG. 1. The electric rear axle 3 also comprises a power electronics unit 15 which is represented here in two parts, and a first actuator schematically represented, labelled with 13a, in order to actuate the first switchable freewheel clutch 13.

By means of the first switchable freewheel clutch 13, the first rotor 6 can be coupled in a torque-transmitting manner to the first rear wheel 7 and/or to the second rear wheel 10 in a torque-transmitting manner, the switchable freewheel clutch 13 being designed in a manner known per se such that, by means of the first switchable freewheel clutch 13, the torque-transmitting coupling of the first rotor 6 to the first rear wheel 7 and/or to the second rear wheel 10 can be produced in a forwards traction operation of the first electric machine 5 without an intervention, more precisely without a change of position of the first actuator 13a, and in a forwards thrust operation or a reverse traction operation of the first electric machine 5, the torque-transmitting coupling can be produced with the intervention, more precisely with a change of position of the first actuator 13a. The first actuator 13a advantageously has an electronics unit which generates an electrical operating voltage due to an electronic signal. The first actuator 13a advantageously also has, for example, a servomotor or a hydraulic or pneumatic actuating element, by means of which the electric operating voltage can be converted into a mechanical application of force.

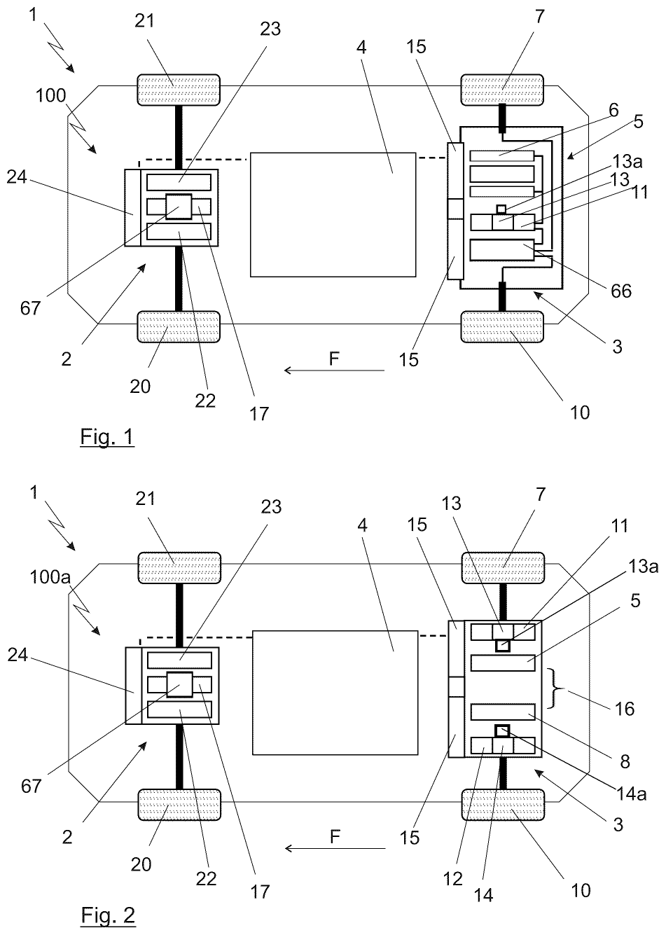

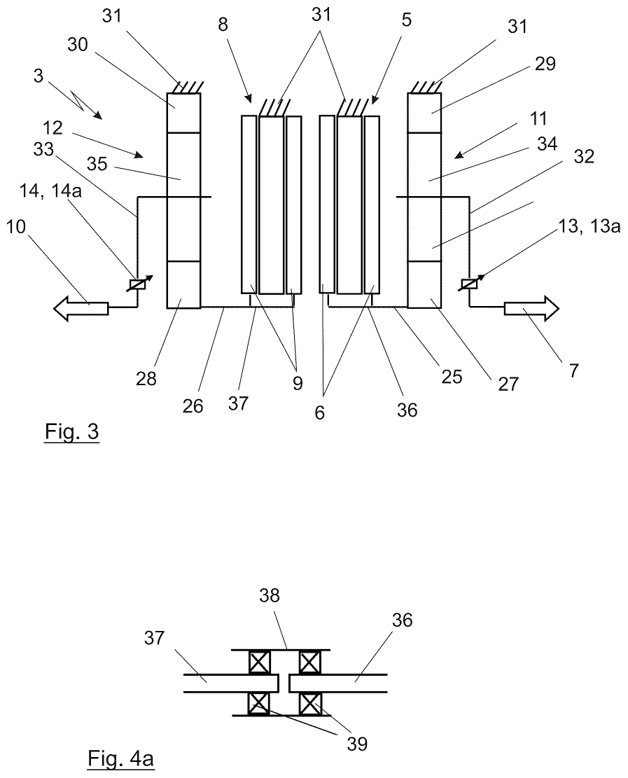

FIG. 2, in which the unchanged features are provided with identical reference numerals, shows a second embodiment of the electric drive system 100a having a third electric engine 8 having a third rotor 9 that can be seen in more detail in FIGS. 3 and 5. The first electric engine 5 and the third electric engine 8 are designed to drive the first rear wheel 7 and the second rear wheel 10. FIGS. 3 and 5 show detailed embodiment possibilities for the electrically driven rear axle 3. It is important, firstly, that a second switchable freewheel clutch 14 is provided for a coupling/decoupling of the third electric engine 8 from the first rear wheel 7 and/or from the second rear wheel 10, which in turn comprises a second actuator 14a. The second switchable freewheel clutch 14 and the associated second actuator 14a are constructed and designed in an identical manner to the first switchable freewheel clutch 13 and the first actuator 13a thereof.

In the second embodiment, the electrically driven rear axle 3 also comprises a first planetary gear stage 11 and a second planetary gear stage 12 for each of the two driven rear wheels 7, 10.

A first possible embodiment of the electrically driven rear axle 3 is now described in detail below. To that end, FIG. 3 shows the two electric engines 5, 8 having the first rotor 6 and the third rotor 9. These rotors 6, 9 are each connected to an input shaft for conjoint rotation, specifically a first input shaft 25 of the first planetary gear stage 11 and a second input shaft 26 of the second planetary gear stage 12. The first input shaft 25 is connected to a first sun gear 27 of the first planetary gear stage 11 for conjoint rotation. The second input shaft 26 is connected to a second sun gear 28 of the second planetary gear stage 12 for conjoint rotation.

In each case, a ring gear 29, 30 of the respective planetary gear stage 11, 12, specifically a first ring gear 29 of the first planetary gear stage 11 and a second ring gear 30 of the second planetary gear stage, is connected for conjoint rotation to a housing 31, preferably a common housing 31 of the electrically driven rear axle 3, indicated by the hatching. Preferably, the first electric engine 5 and the third electric engine 8 and also the first planetary gear stage 11 and the second planetary gear stage 12 can be arranged in the common housing.

A first output shaft 32 of the first planetary gear stage 11 is coupled to first planetary gears 34 of the first planetary gear stage 11 or forms the planetary gear carrier thereof or is connected to this for conjoint rotation. A second output shaft 33 of the second planetary gear stage 12 is coupled to second planetary gears 35 of the second planetary gear stage 12 or forms the planetary gear carrier thereof or is connected to this for conjoint rotation.

This respective output shaft 32, 33 of the respective planetary gear stage 11, 12 is then coupled to associated actuators 13a and 14a having the respective driven rear wheel 7, 10 via the associated switchable freewheel clutch 13, 14, wherein the rear wheels 7, 10 are only indicated here by the arrows symbolizing the torque flow.

The two electric engines 5, 8 of the rear axle 3 can preferably be designed as axial flow machines, which are arranged in the preferably common housing 31 having a common oil chamber. The two planetary gear stages 11, 12 and the switchable freewheels 13, 14 can also be designed integrated therein. The rotors 6, 9 of the rear axle 3 and the planetary gear stages 11, 12 of the rear axle 3 are all preferably arranged coaxially to each other. In other words, the rotors 6, 9 and the planetary gear stages 11, 12 of the rear axle 3 preferably have a common rotational axis. When viewed in an axial direction, in relation to this rotational axis, the first planetary gear stage 11, the first electric engine 5, the third electric engine 8 and the second planetary gear stage 12 are arranged successively. Preferably, they are arranged axially successively in the order mentioned here. Alternatively, the coaxial arrangement could also provide a construction in which in each case one of the planetary gear stages 11, 12 is arranged axially at the same height as and radially inside the respective electric engine 5, 8.

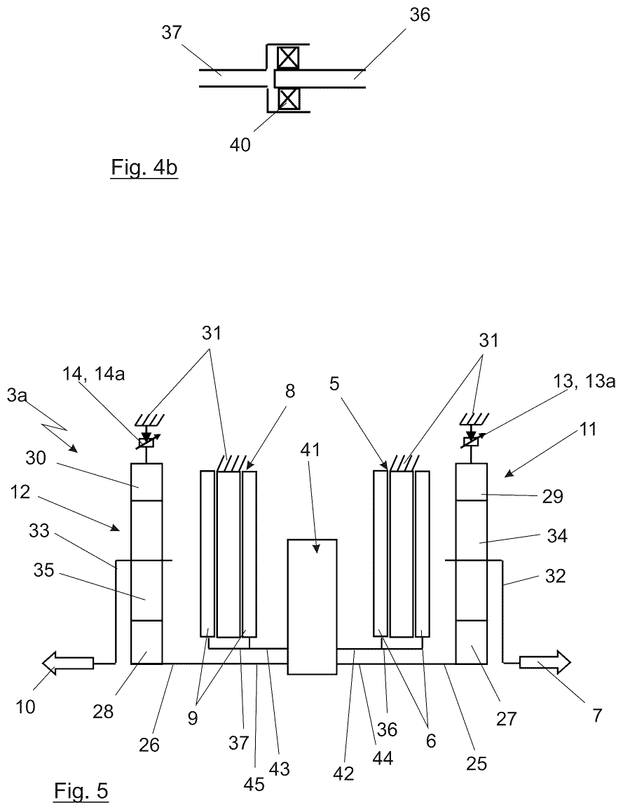

In the illustration of FIG. 4a and FIG. 4b, are two examples showing how two rotor shafts, specifically a first rotor shaft 36 of the first electric engine 5 and a third rotor shaft 37 of the third electric engine 8 can be mounted with respect to each other in an axial region 16 located between the two electric engines 5, 8. The axial region 16 located between the two electric engines 5, 8 is represented in FIG. 2.

Preferably, the two rotor shafts 36, 37 of the first rotor 6 and of the third rotor 9 are exclusively mounted against each other and not with respect to the housing 31, in the axial region 16 located between the two electric engines.

A mounting according to FIG. 4a provides a sleeve 38, in which the ends of the two rotor shafts 36, 37 are mounted via a bearing device 39. The ends of the rotor shafts 36 are arranged radially inside the bearing device 39, and the bearing device 39 is arranged radially inside the sleeve 38. The bearing device 39 preferably has two individual bearings.

An alternative according to FIG. 4b provides that one of the rotor shafts, here the third rotor shaft 37, is designed as a hollow shaft, at least at its end, and accommodates the first rotor shaft 36 via an alternative bearing device 40 inside this hollow shaft, so that the first rotor shaft 36 is arranged radially inside the alternative bearing device 40 and the alternative bearing device 40 is arranged radially inside the hollow shaft end of the third rotor shaft 37. Therefore, the sleeve 38 can be omitted as an independent component.

In the illustration of FIG. 5, an alternative possible embodiment, in comparison to FIG. 3, of the electrically driven rear axle, here labelled with 3a, can be seen. The construction substantially corresponds to that in FIG. 3, so that all components already known from FIG. 3 are provided with the same reference numerals. Therefore, only the differences are discussed in more detail below.

A first difference is that the first switchable freewheel clutch 13 and the second switchable freewheel clutch 14 are displaced. The output shafts 32, 33 of the planetary gear stages 11, 12 are permanently coupled here to the driven wheels 7, 10 or their axles. The switchable freewheels 13, 14 are now located between the respective ring gear 29, 30 of the respective planetary gear stage 11, 12 and the common housing 31. In this arrangement of the switchable freewheels 13, 14, slightly higher losses occur when travelling with open freewheel clutches 13, 14, but the ability to activate the freewheels 13, 14 is improved, as lower torques occur on activation. This arrangement of the freewheels 13, 14 shown in FIG. 5 can also easily be applied to the otherwise unchanged solution in FIG. 3. In this arrangement of the first switchable freewheel 13, a first coupling half of the switchable freewheel 13 is connected to the housing 31 for conjoint rotation, and a second coupling half of the switchable freewheel 13 is connected to the first ring gear 29 for conjoint rotation. The second switchable freewheel 14 is analogously arranged between the housing 31 and the second ring gear 30.

A further difference between the embodiment of FIG. 5 and the one of FIG. 3 is that a superposition gear 41 having a first drive shaft 42, a second drive shaft 43, a first output drive shaft 44, and a second output drive shaft 45 is provided between the first rotor 6 and the third rotor 9, wherein the first rotor 6 is connected to the first drive shaft 42 for conjoint rotation and wherein the third rotor 9 is connected to the second drive shaft 43 for conjoint rotation. The first output drive shaft 44 is in turn connected to the first input shaft 25 of the first planetary gear stage 11 for conjoint rotation, and the second output drive shaft 45 is connected to the second input shaft 26 of the second planetary gear stage 12 for conjoint rotation. In the embodiment of FIG. 5, the superposition gear 41 is arranged axially between the two electric engines 5, 8. However, it is also possible to arrange the superposition gear 41 axially next to the two electric engines 5, 8, wherein one of the two rotor shafts 36, 37 of the rear axle 3a would then extend radially inside the other of the two rotor shafts 36, 37.

Otherwise, the construction of the embodiment of FIG. 5 corresponds as far as possible to the construction described in FIG. 3, wherein, in the construction according to FIG. 5, the two switchable freewheels 13, 14 could also be displaced into the region of the output shafts 32, 33 of the planetary gear stages 11, 12 (analogously to the construction of FIG. 3).

In the illustration of FIGS. 6a and 6b, two possible alternative embodiments for the electrically driven front axle 2 are now shown. In the illustration of FIG. 6a, the electrically driven front axle 2 is designed so that the second electric engine 17 with the second rotor 18 is arranged centrally in the axial direction. The second axle drive 67 is designed as a differential gearbox, which is driven by the second rotor 18 of the second electric engine 17. In particular, an input shaft of the second axle drive 67 can be coupled to the second rotor 18 for conjoint rotation. The input shaft of the second axle drive 67 can, for example, be designed as a differential cage of a bevel gear differential. The output shafts of the second axle drive 67 form respective input shafts, specifically a third input shaft 46 of a third planetary gear stage 48 on the one hand and a fourth input shaft 47 of a fourth planetary gear stage 49 on the other hand.

Similarly to the electrically driven rear axle 3 described above, these input shafts 46, 47 can be coupled to sun gears, specifically a third sun gear 50 of the third planetary gear stage 48 and a fourth sun gear 51 of the fourth planetary gear stage 49. Ring gears, specifically a third ring gear 52 and a fourth ring gear 53, of the two planetary gear stages 48, 49 are in turn held fixed against a further housing 54.

In each case, planetary gear carriers of the respective rotating planets 66, 67 form a third output shaft 55 of the third planetary gear stage 48 and a fourth output shaft 56 of the fourth planetary gear stage 49 and in each case drive one of the two front wheels 20, 21, which are also only indicated here accordingly by the arrows pointing to them, analogous to the preceding illustrations.

The two planetary gear stages 48, 49, the second axle drive 67 and the second electric engine 17 can in this case preferably again be arranged coaxially to their rotational axis of the construction, wherein here only the upper half of the construction rotationally symmetrical around the rotational axis is represented accordingly, just as in FIGS. 3 and 5. The order in the axial direction is in particular such that the first driven front wheel 20 is followed by the third planetary gear stage 48, the second axle drive 67, the fourth planetary gear stage 49 and the second driven front wheel 21. The second electric engine 17 surrounds the second axle drive 67 so that the second axle drive 67 is arranged coaxially to and axially overlapping and radially inside the second electric engine 17.

In FIG. 6b, an alternative construction for the front axle 2 is shown, in which the second electric engine 17 or the second rotor 18 initially introduces torque into a further planetary gear stage 57. The further planetary gear stage 57 is constructed in the example shown here in such a way that the second rotor 18 is connected to its input shaft, here in the form of a fifth sun gear 58, for conjoint rotation, whilst a fifth ring gear 59 of the further planetary gear stage 57 is connected to the further housing 54 for conjoint rotation. The output shaft of this further planetary gear stage 57 in turn forms a planetary gear carrier 60 for fifth planetary gears 61. This planetary gear carrier 60 is connected to a sixth ring gear 62 of a planetary differential as a second axle drive 67a, which drives the first driven front wheel 20 via a double planetary carrier 63 and drives the second driven front wheel 21 via a sixth sun gear 64.

Furthermore, a parking lock 65 can be seen in the illustration of FIG. 6b. This parking lock 65 is arranged between the further planetary gear stage 57 and the second axle drive 67a and serves to secure the drive in the parked state of the motor vehicle 1. In this case, in which the planetary gear carrier 60 is connected for conjoint rotation to the further housing 54 via the parking lock 65 in a closed state of the parking lock 65. Such a parking lock 65 would in principle also be conceivable in the construction shown in FIG. 6a, for example between the second axle drive 67a and the third planetary gear stage 48 or also alternatively (or additionally) for this purpose between the second axle drive 67a and the fourth planetary gear stage 49. In an overall system view of the electric drive system 100, 100a, it is advantageous to integrate the parking lock 65 into the electrically driven front axle 2, 2a and not into the electrically driven rear axle 3, 3a, since the electrically driven front axle 2, 2a provides comparatively more space in this overall system and because an electrically driven front axle 2, 2a designed in such a way could also be used as a module in other conceivable overall systems.

Advantageously, the overall system of the electric drive system 100, 100a can be used to operate a motor vehicle equipped therewith in such a way that, during a change from a forwards traction operation to a forwards thrust operation of the first electric engine 5 by means of the first actuator 13, the torque-transmitting coupling of the first rotor 6 with the first rear wheel 7 and/or the second rear wheel 10 is produced by means of the intervention of the first actuator 13a, if, immediately before the change, a vehicle speed of the motor vehicle is greater than a speed threshold value and if no sports operating mode of the motor vehicle that can be selected by a driver of the motor vehicle is set and if a charge level of the battery 4 is less than a charge level threshold value. The intervention of the first actuator 13a, as already described above, means a position change of a hydraulic or pneumatic piston or of a servomotor of the first actuator 13a. The speed threshold value can advantageously be in a region of 100 km/h. The charge level threshold value can advantageously be in a region of 90% in relation to a total charge capacity of the battery 4.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE NUMERALS

1 motor vehicle
2, 2a front axle
3 rear axle
4 battery
5 first electric engine
6 first rotor
7 first rear wheel
8 third electric engine
9 third rotor
10 second rear wheel
11 first planetary gear stage
12 second planetary gear stage
13 first switchable freewheel clutch
13a first actuator
14 second switchable freewheel clutch
14a second actuator
15 power electronics unit
16 axial region
17 second electric engine
18 second rotor
20 first front wheel
21 second front wheel
22 third planetary gear stage
23 fourth planetary gear stage
24 power electronics unit
25 first input shaft
26 second input shaft
27 first sun gear
28 second sun gear
29 first ring gear
30 second ring gear
31 housing
32 first output shaft
33 second output shaft
34 first planetary gears
35 second planetary gears
36 first rotor shaft
37 second rotor shaft
38 sleeve
39 bearing device
40 alternative bearing device
41 superposition gear
42 first drive shaft
43 second drive shaft
44 first output drive shaft
45 second output drive shaft
46 third input shaft
47 fourth input shaft
48 third planetary gear stage
49 fourth planetary gear stage
50 third sun gear
51 fourth sun gear
52 third ring gear
53 fourth ring gear
54 further housing
55 third output shaft
56 fourth output shaft
57 further planetary gear stage
58 fifth sun gear
59 fifth ring gear
60 planetary gear carrier
61 fifth planetary gears
62 sixth ring gear
63 double planetary carrier
64 sixth sun gear
65 parking lock
66 first axle drive
67,67a second axle drive
100, 100a electric drive system

1-10. (canceled)

11. An electric drive system for a motor vehicle, the electric drive system comprising:
an electrically driven rear axle comprising a first electric engine having a first rotor configured to drive a first rear wheel or a second rear wheel of the electrically driven rear axle and a third electric engine having a third rotor configured to drive the first or second rear wheel;
an electrically driven front axle comprising a second electric engine having a second rotor configured to drive front wheels of the electrically driven front axle via an axle drive, wherein the second rotor is permanently coupled in a torque-transmitting manner via the axle drive to a first front wheel and to a second front wheel;
a first switchable freewheel clutch comprising a first actuator and configured to couple the first rotor to the first rear wheel or to the second rear wheel in a torque-transmitting manner so that a torque-transmitting coupling of the first rotor to the first rear wheel or the second rear wheel is produced in a forwards traction operation of the first electric engine without intervention of the first actuator and the torque-transmitting coupling of the first rotor to the first rear wheel or the second rear wheel is produced with the intervention of the first actuator in a forwards thrust operation or a reverse traction operation of the first electric engine; and
a second switchable freewheel clutch comprising a second actuator and configured to couple the third rotor to the second rear wheel in a torque-transmitting manner,
wherein the first electric engine and the third electric engine are axial flow machines arranged in a common housing having a common oil chamber, and
wherein a first planetary gear stage, a second planetary gear stage, the first switchable freewheel clutch, and the second switchable freewheel clutch are arranged in the common housing and in the common oil chamber.

12. The electric drive system of claim 11, wherein the first planetary gear stage is arranged between the first rotor and the first rear wheel with regard to a torque flow originating from the first rotor, and wherein the first rotor and the first planetary gear stage are arranged coaxially to each other.

13. The electric drive system of claim 12, wherein the first switchable freewheel clutch is configured to couple a first output shaft of the first planetary gear stage to the first rear wheel for conjoint rotation.

14. The electric drive system of claim 12, wherein the first switchable freewheel clutch is configured to connect an element of the first planetary gear stage to the common housing for conjoint rotation.

15. The electric drive system of claim 12, further comprising:
a superposition gear comprising a first drive shaft, a second drive shaft, a first output drive shaft, and a second output drive shaft, wherein the superposition gear is arranged axially between the first rotor and the third rotor, wherein the first rotor is connected to the first drive shaft for conjoint rotation, the third rotor is connected to the second drive shaft for conjoint rotation, the first output drive shaft is connected to a first input shaft of the first planetary gear stage for conjoint rotation, and the second output drive shaft is connected to a second input shaft of the second planetary gear stage for conjoint rotation.

16. The electric drive system of claim 11, further comprising:
a first rotor shaft of the first rotor mounted axially between the first rotor and the third rotor against a third rotor shaft of the third rotor.

17. The electric drive system of claim 11, wherein the second electric engine, the second axle drive, a third planetary gear stage, and the first front wheel are arranged successively in recited order with regard to a torque flow originating from the second electric engine, and wherein the second electric engine, the second axle drive, a fourth planetary gear stage, and the second front wheel are arranged successively in recited order with regard to the torque flow originating from the second electric engine.

18. The electric drive system of claim 11, wherein the second electric engine, a further planetary gear stage, the second axle drive, and the first front wheel originating from the second axle drive are each arranged successively in recited order with regard to a torque flow originating from the second electric engine and wherein the second electric engine, a further planetary gear stage, the second axle drive, and the second front wheel originating from the second axle drive are each arranged successively in recited order with regard to the torque flow originating from the second electric engine.

19. The electric drive system of claim 18, further comprising:
a parking lock connected between the further planetary gear stage and the axle drive with regard to the torque flow.

20. A method for operating a motor vehicle having an electric drive system and a battery, wherein the electric drive system comprises an electrically driven rear axle comprising a first electric engine having a first rotor configured to drive a first rear wheel or a second rear wheel of the electrically driven rear axle and a third electric engine having a third rotor configured to drive the first or second rear wheel; an electrically driven front axle comprising a second electric engine having a second rotor configured to drive front wheels of the electrically driven front axle via a second axle drive, wherein the second rotor is permanently coupled in a torque-transmitting manner via the second axle drive to a first front wheel and to a second front wheel; a first switchable freewheel clutch comprising a first actuator and configured to couple the first rotor to the first rear wheel or to the second rear wheel in a torque-transmitting manner so that a torque-transmitting coupling of the first rotor to the first rear wheel or the second rear wheel is produced in a forwards traction operation of the first electric engine without intervention of the first actuator and the torque-transmitting coupling of the first rotor to the first rear wheel or the second rear wheel is produced with the intervention of the first actuator in a forwards thrust operation or a reverse traction operation of the first electric engine; and a second switchable freewheel clutch comprising a second actuator and configured to couple the third rotor to the second rear wheel in a torque-transmitting manner, wherein the first electric engine and the third electric engine are axial flow machines arranged in a common housing having a common oil chamber, and wherein a first planetary gear stage, a second planetary gear stage, the first switchable freewheel clutch, and the second switchable freewheel clutch are arranged in the common housing and in the common oil chamber, the method comprising:
determining that a vehicle speed of the motor vehicle is greater than a speed threshold value immediately before a change from a forwards traction operation to a forwards thrust operation of the first electric engine;
determining that a sports operating mode of the motor vehicle is not set, wherein the sports operating mode is selectable by a driver of the motor vehicle;
determining that a charge level of the battery is less than a charge level threshold value; and
producing, responsive to the determining that the vehicle speed of the motor vehicle is greater than the speed threshold value, the determining that the sport operating mode is not set, and the determining that the charge level of the battery is less than the charge level threshold value, the torque-transmitting coupling of the first rotor to the first rear wheel or the second rear wheel by intervention of the first actuator when changing from the forwards traction operation to the forwards thrust operation of the first electric engine.
